(19) United States
(12) Patent Application Publication
(10) Pub. No.: US 2009/0029185 A1
(43) Pub. Date: Jan. 29, 2009

(54) MAGNETIC DEVICE AND MANUFACTURING METHOD THEREOF

(76) Inventors: Cheng-Chang Lee, Taoyuan Hsien (TW); Ming-Hsien Lin, Taoyuan Hsien (TW); Yu-Ru Chang, Taoyuan Hsien (TW); Zong-Ting Yuan, Taoyuan Hsien (TW); Heng-Chung Chang, Taoyuan Hsien (TW); Huang-Kun Chen, Taoyuan Hsien (TW); Tai-Kang Shing, Taoyuan Hsien (TW)

Correspondence Address: BIRCH STEWART KOLASCH & BIRCH, PO BOX 747, FALLS CHURCH, VA, 22040-0747, US

(21) Appl. No.: 12/022,040

(22) Filed: Jan. 29, 2008

(30) Foreign Application Priority Data
Jul. 27, 2007 (TW) 096127440

(51) Int. Cl. H01F 41/02; H01F 5/00

(52) U.S. Cl. 428/573; 264/255; 264/611; 430/318; 264/163; 427/116

(57) ABSTRACT

A manufacturing method of a magnetic device includes the steps of forming a magnetic substrate having a plurality of recesses, and forming at least one coil in the recess. In addition, a magnetic device is also disclosed. The magnetic device includes a magnetic substrate and at least one coil. The magnetic substrate has a plurality of recesses and the coil is disposed in the recess.

### CROSS REFERENCE TO RELATED APPLICATIONS

This Non-provisional application claims priority under 35 U.S.C. §119(a) on Patent Application No(s). 096127440 filed in Taiwan, Republic of China on Jul. 27, 2007, the entire contents of which are hereby incorporated by reference.

### BACKGROUND OF THE INVENTION

1. Field of Invention

The invention relates to a magnetic device and a manufacturing method thereof.

2. Related Art

Magnetic devices have been widely applied to inductors or noise filters of electronic products. The conventional magnetic devices are made by winding enameled copper wires around magnetic cores. However, the miniaturization of the conventional magnetic devices is restricted by the conventional manufacturing apparatuses, the width of the copper wires and the size of the magnetic cores. Compared with the conventional manufacturing method of winding, the micro-fabrication technology can bring smaller inductors and filters, such as the common-mode noise filters.

In order to manufacture a magnetic device such as an inductor, a ferrite that can fit to high frequency operation is often used as a substrate. Then a coil is formed on the ferrite by the micro-fabrication technology. As show in FIG. 1, a coil 13 and two non-magnetic materials 14 and 15 are disposed between two ferrite substrates 11 and 12 so as to form a magnetic device 1. Because the magnetic device 1 must be surface-planarized, the non-magnetic materials 14 and 15 are indispensable and the thicknesses thereof must be greater than a certain value. Hence the whole thickness of the magnetic device 1 is larger than that desired. Furthermore, the coil 13 is surrounded by the non-magnetic materials 14 and 15, so the inductance of the magnetic device 1 is reduced.

As shown in FIG. 2, a first ferrite 22, a coil 23, a second ferrite 24 and two external electrodes 25 are formed on a substrate 21 in sequence by screen printing, and then sintered to form a magnetic device 2. Because the coil 23 of the magnetic device 2 is directly surrounded by the ferrites 22, 24, the magnetic device 2 can be thinner and higher inductance. However, since the sintering temperature is up to 1000° C. to 1200° C., the usable material of the coil 23 is limited. For example, aluminum can not be adopted as the material of the coil 23.

As shown in FIG. 3, a first ferrite 32, a seed layer 35, a coil 33, a second ferrite 34 and a protection layer 36 are formed in sequence on a substrate 31 by electroplating to form a magnetic device 3. Because the coil 33 of the magnetic device 3 is directly surrounded by the ferrites 32, 34, the magnetic device 3 can become thinner and higher inductance. However, the magnetic properties of the ferrites 32 and 34 made by a ferrite plating method are poorer than that of the ferrites made by sintering. Thus, the magnetic device 3 has worse inductance and quality factor (Q) than that of the magnetic device 2.

Therefore, there is a need to provide a magnetic device and a manufacturing method thereof that can become thinner and higher inductance and have no limitation on the material of the coil.

### SUMMARY OF TEE INVENTION

In view of the foregoing, the invention is to provide a magnetic device and a manufacturing method thereof that can become thinner and higher inductance and has no limitation on the material of the coil.

To achieve the above, the invention discloses a manufacturing method of a magnetic device including the steps of: forming a magnetic substrate having at least one recess, and forming at least one coil at the recess.

To achieve the above, the invention also discloses a magnetic device includes a magnetic substrate and at least one coil. The magnetic substrate has at least one recess, and the coil is disposed in the recess.

As mentioned above, the magnetic substrate of the invention is formed in advance, and the magnetic substrate has the recess for accommodating the coil. Compared with the prior art, because the coil is directly surrounded by the magnetic substrate in the invention, the magnetic device has a thinner thickness and higher inductance. Furthermore, in the invention the coil is formed after the magnetic substrate is made, so the magnetic substrate can be made by sintering if the material of the substrate is ferrite. Therefore, the magnetic substrate can have pretty good magnetic properties, and the material of the coil is not limited because of the high temperature process.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a first conventional magnetic device;

FIG. 2 is a schematic view of a second conventional magnetic device;

FIG. 3 is a schematic view of a third conventional magnetic device;

FIGS. 4A to 4F are schematic diagrams of magnetic devices according to various embodiments of the invention;

FIGS. 5A to 5D are schematic diagrams showing the manufacturing steps of two of the magnetic devices according to the embodiments of the invention;

FIGS. 6A to 6C are schematic diagrams showing a first manufacturing method of the recess of the magnetic device according to the embodiments of the invention;

FIGS. 7A to 7C are schematic diagrams showing a second manufacturing method of the recess of the magnetic device according to the embodiments of the invention; and

FIGS. 8A to 8C are schematic diagrams showing a third manufacturing method of the recess of the magnetic device according to the embodiments of the invention.

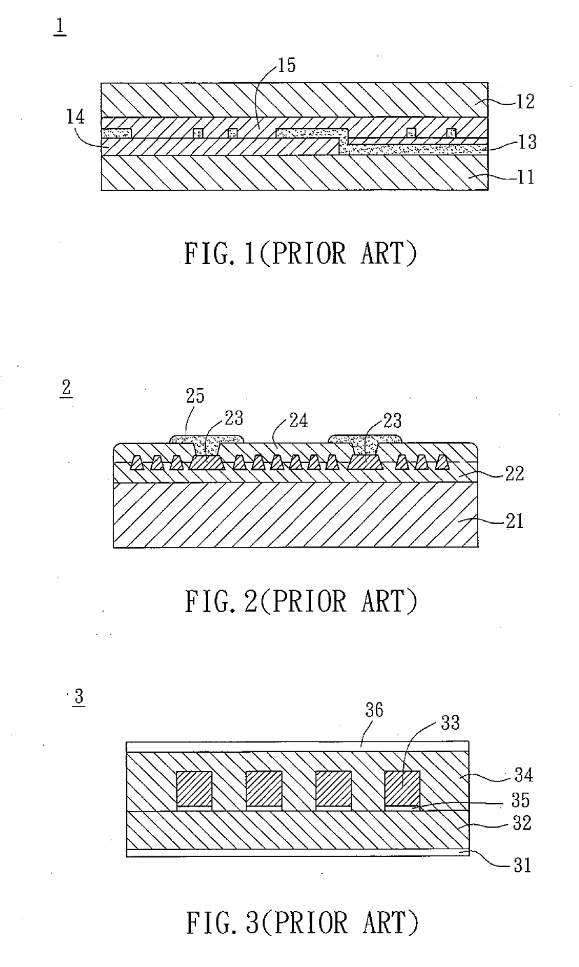

### DETAILED DESCRIPTION OF THE INVENTION

The present invention will be apparent from the following detailed description, which proceeds with reference to the accompanying drawings, wherein the same references relate to the same elements.

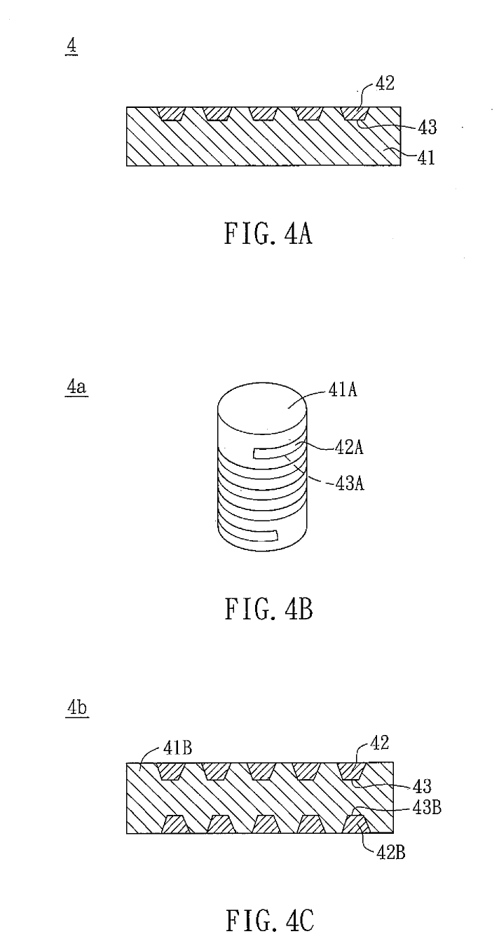

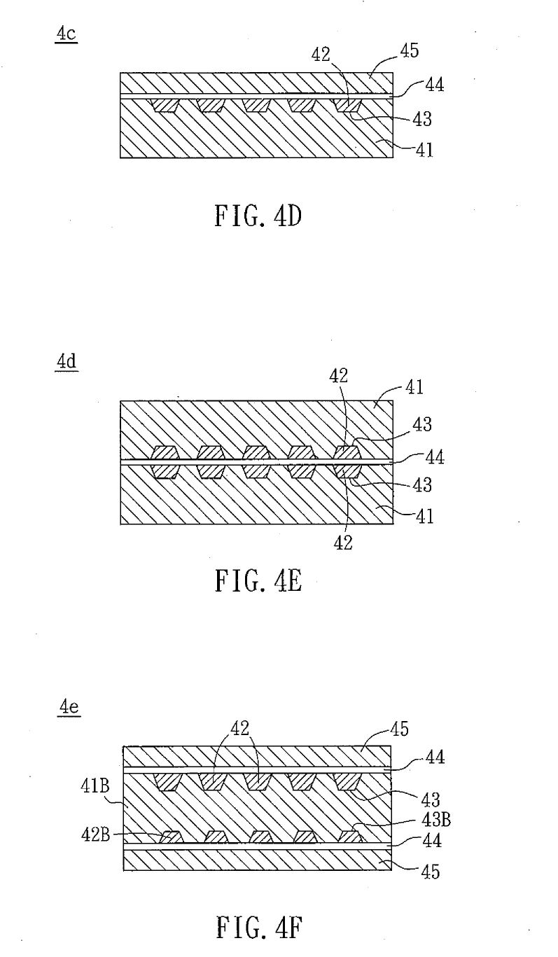

As shown in FIG. 4A, a magnetic device 4 according to an embodiment of the invention includes a magnetic substrate 41 and at least one coil 42. The magnetic substrate 41 can be formed by sintering or curing. The magnetic substrate 41 has at least one recess 43 disposed on one side of the magnetic substrate 41 for accommodating the coil 42. If the magnetic substrate 41 is formed by sintering, the material of the magnetic substrate 41 can be ferrite mixed with a binder. The ferrite can be, for example, NiZn ferrite or MnZn ferrite. If the magnetic substrate 41 is formed by curing, the material of the magnetic substrate 41 can be a metal soft magnetic powder mixed with a polymer material as the isolation among magnetic particles. In addition, the material of the coil 42 can be alloy or metal such as copper or aluminum.

In the embodiment, the magnetic device 4 can have several variations, for example as shown in FIGS. 4B to 4F.

As shown in FIG. 4B, the magnetic substrate 41A of the magnetic device 4a is a cylindrical magnetic core, and the recess 43A is disposed on the outer surface of the magnetic core. The coil 42A is disposed in the recess 43A.

As shown in FIG. 4C, in the magnetic device 4b, the recesses 43 and 43B are disposed on the opposite sides of the magnetic substrate 41B. The coils 42 and 42B are disposed in the recesses 43 and 43B, respectively, so that the magnetic device 4b has the coils 42 and 42B disposed at its opposite sides.

As shown in FIG. 4D, the magnetic device 4c further includes a non-magnetic material 44 formed on the coil 42 and the magnetic substrate 41 with recesses 43 accommodating the coil 42. Therefore, the coil 42 is disposed between the non-magnetic material 44 and the magnetic substrate 41. Moreover, the magnetic device 4c further includes another magnetic substrate 45 which is connected to the non-magnetic material 44. In the embodiment, the non-magnetic material 44 can be oxide, nitride, spin-on glass (SOG), polymer material, epoxy resin or any other material with adhesion or insulation function. Therefore, the magnetic substrate 45 can adhere to the magnetic substrate 41 through the non-magnetic material 44, and the short circuit of the coil 42 due to the material of the magnetic substrate 45 can be prevented. Furthermore, the additional magnetic substrate 45 can increase the inductance of the magnetic device 4c and decrease the inductor loss.

As shown in FIG. 4E, two magnetic devices 4 are connected oppositely to form the magnetic device 4d. In the embodiment, the magnetic devices 4 can be adhered to each other and separated by the non-magnetic material 44.

As shown in FIG. 4F, two magnetic substrates 45 are adhered to the top and bottom sides of the magnetic device 4b, respectively, to form the magnetic device 4e. In the embodiment, the magnetic substrates 45 can be adhered to the magnetic device 4b through the non-magnetic materials 44.

The magnetic devices 4, 4a, 4c with one-sided coil can be applied to the inductors or some electronic devices with one-sided coil. The magnetic devices 4b, 4d and 4e with two-sided coils can be applied to the filters, transformers, double-layer inductors or some electronic devices with two-sided coils.

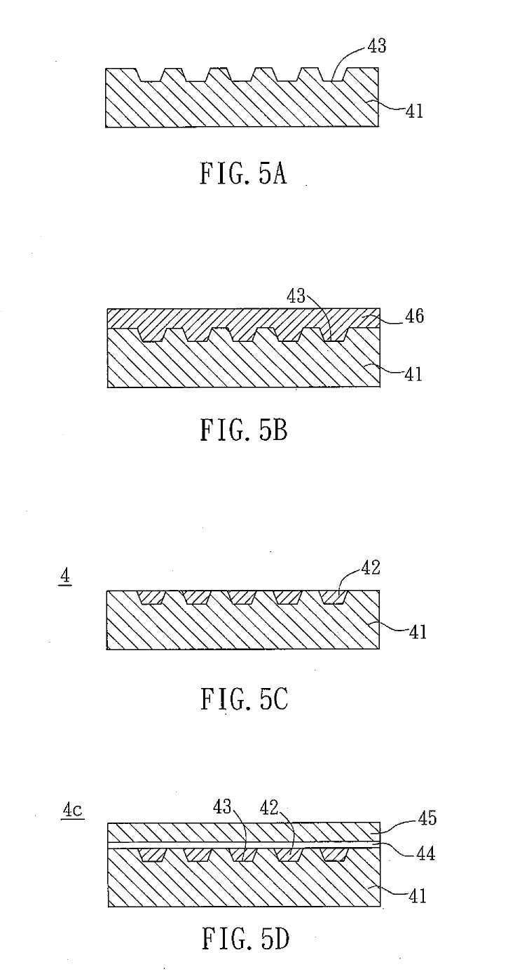

With reference to FIGS. 5A to 5D, the manufacturing method of the magnetic devices 4, 4c of the invention is illustrated as follows.

At first, as shown in FIG. 5A, a magnetic substrate 41 having at least one recess 43 is formed by sintering or curing a magnetic base. Next, as shown in FIG. 5B, a metal layer 46 is formed in the recesses 43. Then, as shown in FIG. 5C, a portion of the metal layer 46 is removed for forming the coil 42. Through the above-mentioned steps, the magnetic device 4 can be manufactured. In the embodiment, the metal layer 46 can be formed by electroplating, electroless plating or deposition. Alternatively, the metal layer 46 can be made by screen printing a copper paste or a silver paste on the recesses 43, and then is cured. The portion of the metal layer 46 can be removed by a semiconductor process, a MEMS process or a grinding process.

In addition, as shown in FIG. 5D, the manufacturing method further includes a step of forming a non-magnetic material 44 at one side of the coil 42, so that the coil 42 can be disposed between the non-magnetic material 44 and the magnetic substrate 41. Then, another magnetic substrate 45 is provided to connect to the non-magnetic material 44, thereby forming the magnetic device 4c. In the embodiment, the non-magnetic material 44 can be formed by deposition or coating. The magnetic substrate 45 can connect to the non-magnetic material 44 by adhesion or wedging.

To be noted that the magnetic devices 4a, 4b, 4d, 4e can also be made by the above-mentioned manufacturing method. For the magnetic device 4a, the magnetic substrate 41a is cylindrical so that it can be rotated to make the metal layer uniformly formed thereon. For the magnetic device 4b, because the recesses are disposed in two sides of the magnetic device 4b, two metal layers are needed. For the magnetic device 4d, two magnetic devices 4 can be manufactured in advance and then adhered to each other through the non-magnetic material 44. For the magnetic device 4e, it can be formed by the manufacturing processes of the magnetic device 4b and the magnetic device 4c.

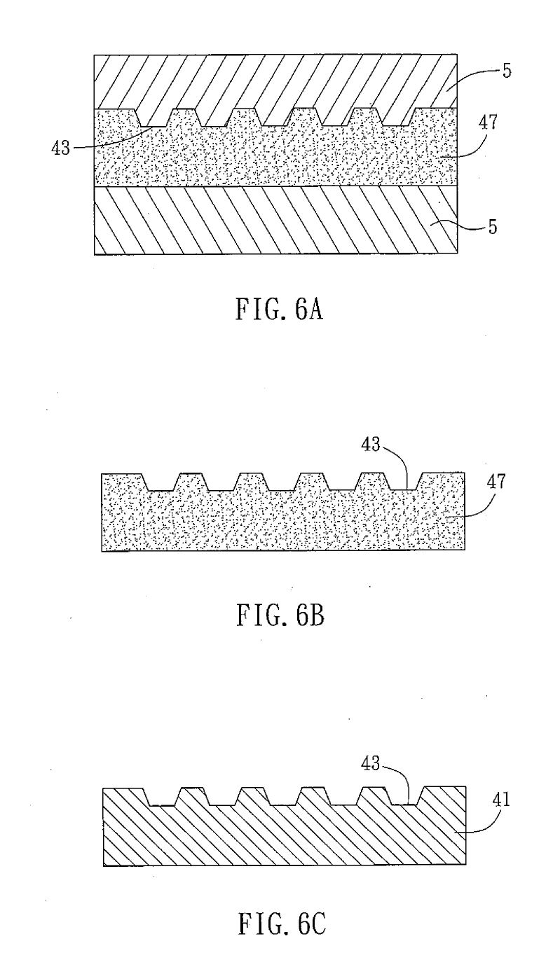

In the above embodiments, the recesses of the magnetic substrate can be formed by many methods. The first method for forming the recesses is illustrated below with reference to FIGS. 6A to 6C.

As shown in FIG. 6A, a magnetic powder is disposed into a mold 5, which has the structure corresponding to the recess 43. Then, the magnetic powder in the mold 5 is pressurized to form a magnetic base 47. In the embodiment, the structure of the mold 5 corresponding to the recess 43 can be made by ordinary machining, etching, electrical discharge machining (EDM) or micro electroforming with UVLIGA technology. The magnetic powder can include ferrite and polymer material as binder; otherwise, it can include metal soft magnetic powder and polymer material. As shown in FIG. 6B, the mold 5 is then removed. As shown in FIG. 6C, the magnetic base 47 is processed to form the magnetic substrate 41 with the recess 43. Herein, the magnetic base 47 containing ferrite powder can be sintered to form the magnetic substrate 41, and the magnetic base 47 containing metal soft magnetic powder can be cured to form the magnetic substrate 41. To be noted, the recess 43 is formed before the magnetic base 47 is sintered or cured.

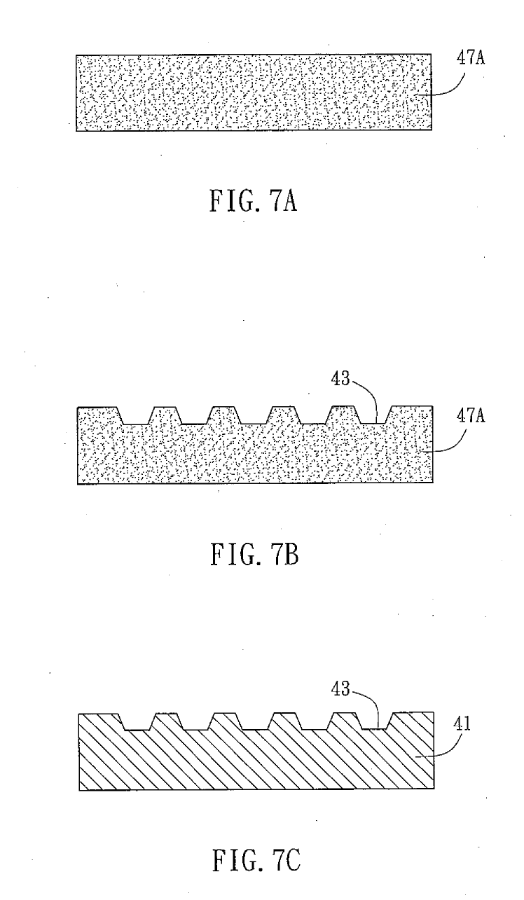

The second method for forming the recess 43 is illustrated below with reference to FIGS. 7A to 7C.

As shown in FIG. 7A, a magnetic base 47A, which has not been sintered or cured, is provided. As shown in FIG. 7B, the recess 43 is formed on the magnetic base 47A. In the embodiment, the recess 43 can be formed by a turning process, a MEMS process, a semiconductor process, an impression process or a grinding process. The MEMS or semiconductor process can include the steps of coating a photoresist layer on the magnetic base 47A, disposing a mask having the pattern corresponding to the recess 43 over the photoresist layer, exposing and developing the photoresist through the mask etching the magnetic base 47A, and removing the residual photoresist to obtain the recess 43. As shown in FIG. 7C, the magnetic base 47A is sintered or cured to form the magnetic substrate 41 with the recess 43. In the embodiment, the recess 43 is also formed before the magnetic base 47A is sintered or cured.

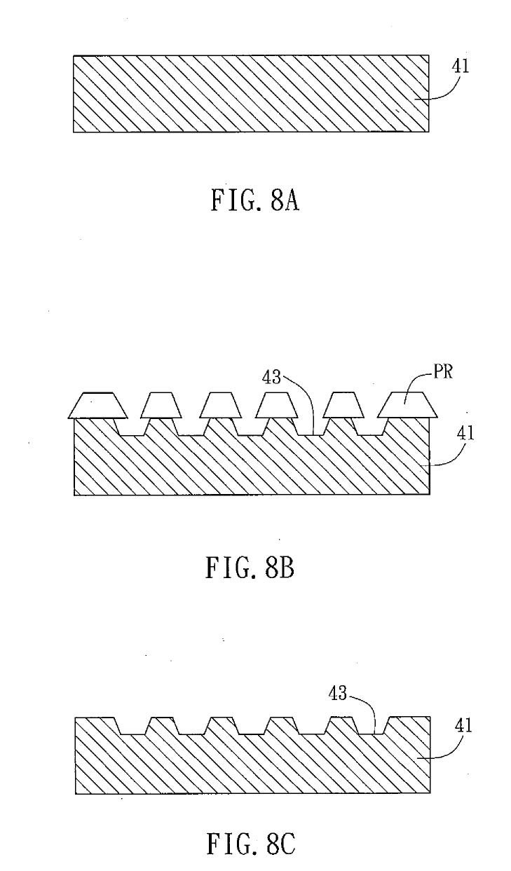

The third method for forming the recess 43 is illustrated below with reference to FIGS. 8A to 8C.

As shown in FIG. 8A, a magnetic base is sintered or cured to form a magnetic substrate 41. As shown in FIG. 8B, the recess 43 is formed on the magnetic substrate 41. In the embodiment, the recess 43 can be formed by a milling process, a semiconductor process or a MEMS process. The MEMS or semiconductor process can include the steps of: coating a photoresist layer PR on the magnetic substrate 41, disposing a mask having the pattern corresponding to the recess 43 over the photoresist layer PR, exposing and developing the photoresist layer PR through the mask, etching the magnetic base 47A (as shown in FIG. 8B), and removing the photoresist remaining to obtain the recess 43 (as shown in FIG. 8C). To be noted, the recess 43 of this embodiment is formed after the magnetic base 47 is sintered or cured.

In summary, the magnetic substrate of the invention is formed in advance, and the magnetic substrate has the recess for accommodating the coil. Compared with the prior art, the coil of the invention is directly surrounded by the magnetic substrate, so the magnetic device has a thinner thickness and higher inductance. Furthermore, the coil is formed after sintering or curing the magnetic substrate, so the magnetic substrate can have good magnetic properties. In addition, the material of the coil is not limited due to the high temperature process.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A manufacturing method of a magnetic device comprising steps of:
forming a first magnetic substrate having at least one recess; and
forming at least one coil in the recess.

2. The manufacturing method as recited in claim 1, wherein the first magnetic substrate is formed by sintering or curing a magnetic base, and the recess is formed on the magnetic base before the magnetic base is sintered or cured.

3. The manufacturing method as recited in claim 2, wherein before the step of sintering or curing the magnetic base, the manufacturing method further comprises steps of:
disposing a magnetic powder into a mold having a structure corresponding to the recess;
pressing the magnetic powder to form the magnetic base; and
removing the mold.

4. The manufacturing method as recited in claim 2, wherein before the step of sintering or curing the magnetic base, the manufacturing method further comprises a step of forming the recess on the magnetic base through a turning process, a MEMS process, a semiconductor process, an impression process or a grinding process.

5. The manufacturing method as recited in claim 2, wherein after the step of forming the first magnetic substrate, the manufacturing method further comprises a step of forming the recess on the first magnetic substrate by milling machining, EDM, laser machining a semiconductor process or a MEMS process.

6. The manufacturing method as recited in claim 4, wherein the MEMS process or the semiconductor process comprises steps of:
coating a photoresist layer on the magnetic base;
disposing a mask with a pattern corresponding to the recess on the photoresist layer;
exposing and developing the photoresist through the mask;
etching the magnetic base; and
removing the photoresist so as to form the recess.

7. The manufacturing method as recited in claim 5, wherein the MEMS process or the semiconductor process comprises steps of:
coating a photoresist layer on the magnetic base;
disposing a mask with a pattern corresponding to the recess on the photoresist layer;
exposing and developing the photoresist through the mask;
etching the magnetic base; and
removing the photoresist so as to form the recess.

8. The manufacturing method as recited in claim 1, wherein the step of forming the coil comprises steps of:
forming a metal layer on the recess; and
removing a portion of the metal layer to form the coil.

9. The manufacturing method as recited in claim 7, wherein the metal layer is formed by electroplating, electroless plating, deposition, or curing a copper paste or a silver paste printed in the recess, and the portion of the metal layer is removed by a semiconductor process, a MEMS process or a grinding process.

10. The manufacturing method as recited in claim 1, wherein after the step of forming the coil, the manufacturing method further comprises:
forming a non-magnetic material on the first magnetic substrate and the coil.

11. The manufacturing method as recited in claim 10, wherein the non-magnetic material is formed by deposition or coating, and the non-magnetic material comprises oxide, nitride, spin-on glass (SOG), a polymer material, an epoxy resin or an insulation material.

12. The manufacturing method as recited in claim 10, further comprising a step of forming a second magnetic substrate for connecting to the non-magnetic material by adhesion or wedging.

13. The manufacturing method as recited in claim 12, wherein the second magnetic substrate has at least one recess and at least one coil is disposed in the recess of the second magnetic substrate.

14. The manufacturing method as recited in claim 1, further comprising steps of:
forming two connection materials on opposite sides of the first magnetic substrate; and
connecting the connection materials to a second magnetic substrate and a third magnetic substrate, respectively.

15. A magnetic device comprising:
a first magnetic substrate having at least one recess; and
at least one coil disposed in the recess.

16. The magnetic device as recited in claim 15, wherein the first magnetic substrate has a plurality of recesses, and the recesses are disposed on opposite sides or one side of the first magnetic substrate.

17. The magnetic device as recited in claim 16, wherein when the coil is disposed on one side of the first magnetic substrate, the magnetic device is an inductor, and when the coils are disposed on the opposite sides of the first magnetic substrate, the magnetic device is a filter, a transformer or a double-layer inductor.

18. The magnetic device as recited in claim 15, wherein the first magnetic substrate is a magnetic core, or a cylindrical magnetic core, and the recess is disposed on an outer surface of the magnetic core.

19. The magnetic device as recited in claim 14, wherein a material of the first magnetic substrate comprises ferrite, NiZn ferrite, MnZn ferrite or metal soft magnetic powder mixed with a polymer material.

20. The magnetic device as recited in claim 15, wherein a material of the coil comprises metal, alloy, copper or aluminum.

21. The magnetic device as recited in claim 15, further comprising a non-magnetic material disposed on the coil and the first magnetic substrate such that the coil is disposed between the non-magnetic material and the first magnetic substrate.

22. The magnetic device as recited in claim 21, further comprising a second magnetic substrate connected to the nonmagnetic material, wherein the second magnetic substrate has at least one recess and at least one coil is disposed in the recess of the second magnetic.

23. The magnetic device as recited in claim 15, further comprising:
two non-magnetic materials disposed on opposite sides of the first magnetic substrate; and
a second magnetic substrate and a third magnetic substrate connected to the non-magnetic materials, respectively.

24. The magnetic device as recited in claim 20, wherein a material of the non-magnetic material comprises oxide, nitride, SOG, polymer material or epoxy resin.
